(19) United States
(12) Patent Application Publication
(10) Pub. No.: US 2025/0259256 A1
(43) Pub. Date: Aug. 14, 2025

(54) LAW ENFORCEMENT EXCHANGE INTERFACE

(71) Applicant: LX Solutions, LLC, Nashville, NC (US)

(72) Inventor: Elliot Z. Gruhn, Winterville, NC (US)

(21) Appl. No.: 18/440,133

(22) Filed: Feb. 13, 2024

(51) Int. Cl. G06Q 50/26

(52) U.S. Cl. CPC G06Q 50/265

(57) ABSTRACT

A secure and centralized information sharing network designed to enhance public safety and increase operational efficiency through real-time collaboration, systems integration, and process automation.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a system to aid law enforcement. In particular, it relates to a system that allows law enforcement to organize critical information from different sources and coordinate the critical information so it can be analyzed and visually displayed to solve crimes.

### Description of Related Art

Law enforcement agencies are responsible for the organization of crime statistics and data interpretation. Typically, law enforcement must find multiple sources of disconnected information and have the experience to know what information it needs. Unfortunately, there are multiple independent sources of this information available. These take time to load, analyze, and make meaningful interpretations of the data because they are separate and do not interact with each other. Many law enforcement missions are time sensitive as well, such that having to go to multiple disparate sources takes longer than is needed. It is common to have more than 50 different sites making it difficult to remember if you have reviewed all of the appropriate databases. Having a mere collection of databases alone is not sufficient to be able to know where to go and how to get the databases to interact or select which data is important to the particular crime or event being investigated within a time critical endeavor. When they are separate this is impossible even if in the same location.

### BRIEF SUMMARY OF THE INVENTION

The present invention relates to a secure real-time online system for law enforcement to investigate time sensitive situations with information at different locations including digital and non-digital information comprising:
a) a dashboard for accessing information which allows a user to have interactions between multiple information sources via a navigation page;
b) an intelligence map that geocodes at least one of the locations of crimes, calls for law enforcement service, wanted subjects, and gang members on a map;
c) an intelligence map to see where crimes and calls for service are occurring, which enable the user to discern crime trends in real time;
d) an identity investigation tool;
e) a secured host system which provides interactive connections to information; and
f) a user access system requiring a two-factor authentication.

### BRIEF DESCRIPTION OF THE DRAWINGS

FIG. 1 is an embodiment of a dashboard for accessing all information necessary for real time crime solving.

FIG. 2 is an embodiment of an intelligence map.

FIG. 3 is an embodiment of an identity investigation tool.

FIG. 4 is an embodiment of a wanted persons dashboard.

FIG. 5 is an embodiment of a gang validation dashboard.

FIG. 6 is an embodiment of a gang intelligence mapping interface.

FIG. 7 is an embodiment of a calls for service and crime mapping interface.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

It is further noted that the claims may be drafted to exclude any element which may be optional. As such, this statement is intended to serve as antecedent basis for use of such exclusive terminology as “solely”, “only” and the like in connection with the recitation of claim elements, or the use of a “negative” limitation.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. To the extent such publication may set out definitions of a term that conflict with the explicit or implicit definition of the present disclosure, the definition of the present disclosure controls.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “secure” refers to a system to decrease the likelihood of someone hacking into the system. A two-factor authentication method with idle session timeouts and automated password reset policies in accordance with the Criminal Justice Information Services (CJIS) policies provide such security.

As used herein, the term “real-time online system” refers to the ability for the present system to provide access to disparately located information all at the same time as the user looks at information relating to an active police case. The system integrates disparate information in one location and houses real time information on time sensitive missions' critical information which needs to be accessed in real time to be of any value in dealing with the time sensitive mission.

As used herein, the term “time sensitive situations” refers to investigations which, if not done promptly, cannot be done at all such as missing persons, stolen vehicles, wanted subjects gang members, crime hot spots and the like.

As used herein, the term “different locations” refers to information both digital and nondigital which exist in different agencies in different locations which normally don't communicate with each other, but which all need to be accessed in real time to deal with a time sensitive situation.

As used herein, the term “digital and non-digital” refers to information that is in digital accessible form on the system and to non-digital which can be uploaded for use by the user.

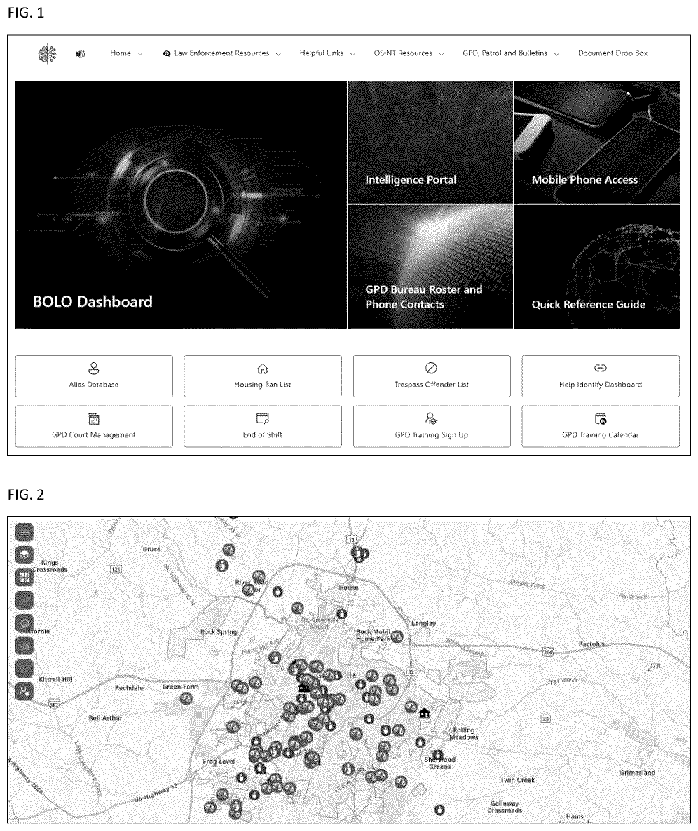

As used herein, the term “dashboard for accessing all information” refers to a web page what allows the user to decide what information the user needs for the particular situation. An embodiment of a dashboard is seen in FIG. 1.

As used herein, the term “wanted persons dashboard” refers to a particular function of the system that allows viewing pictures of suspects (FIG. 4). It also indicates a location type map where individual suspects can be geocoded and shown on an intelligence map FIG. 2.

As used herein, the term “law enforcement forms” refers to the forms that law enforcement needs to fill out during work on a time sensitive situation.

As used herein, the term “secured host access system” refers to the system being as secure as possible from hacks or other unauthorized uses. The system in one embodiment uses a 2-factor authentication system to gain access or an equivalent. As an embodiment use of Microsoft SharePoint can be utilized. In addition, automated password reset and idle timeouts can be used.

As used herein, the term “convert non-digital to digital” refers to scanning non-digital form in order to have them available to a user in real time.

As used herein the term “gang validation database” refers to a user-friendly, secure web-based investigation, analytical, and statistical resource for recording and tracking gangs, gang members and their activities. The Database allows you to document and track gangs, gang members and gang related incidents, and provides analytical tools to discern trends, relationships, patterns, and gang demographics. The Database uses dropdowns, partial word searching support, calendar controls, drilldown forms, wildcards, etc., to make entering and retrieving useful information easy. The Database is an information sharing application that operates in Microsoft's Government Community Cloud (GCC).

As used herein the term “Gang Intelligence Mapping Interface refers to a user-friendly, secure web-based data visualization tool used as an investigative, analytical, and statistical resource for tracking gangs, gang members and their activities. GIMI allows you to track gangs, gang members and gang related incidents, and provides for analytical tools to discern trends, relationships, patterns, and gang demographics. GIMI uses an interactive map, dropdowns, partial word searching support, drilldown options, wildcards, etc., to make retrieving useful information easy. The Dashboard is an information sharing application that operates in Microsoft's Government Community Cloud (GCC).

### DRAWINGS

Now referring to the drawings, FIG. 1 is an embodiment of a dashboard for accessing all information necessary for real time crime solving.

FIG. 2 is an embodiment of an intelligence map.

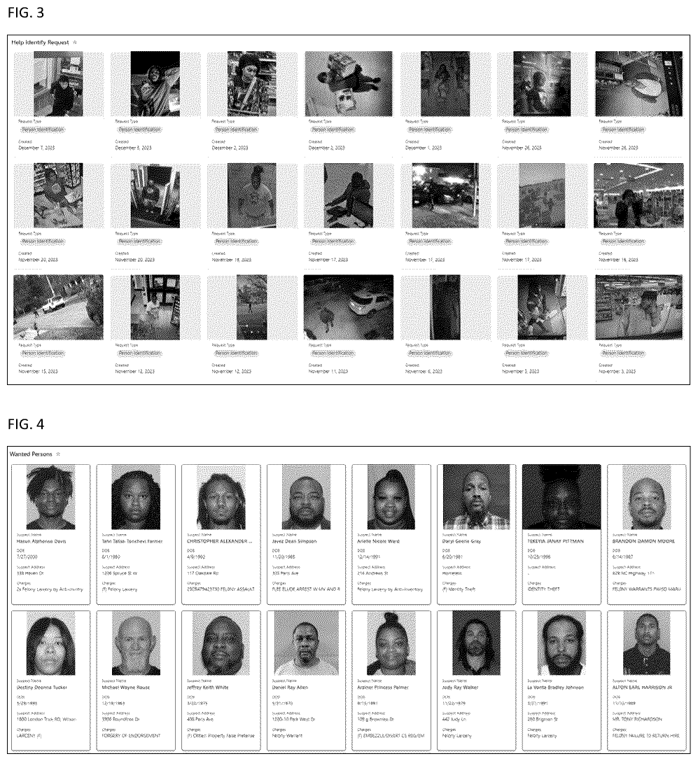

FIG. 3 is an embodiment of an identity investigation tool.

FIG. 4 is an embodiment of a wanted person dashboard.

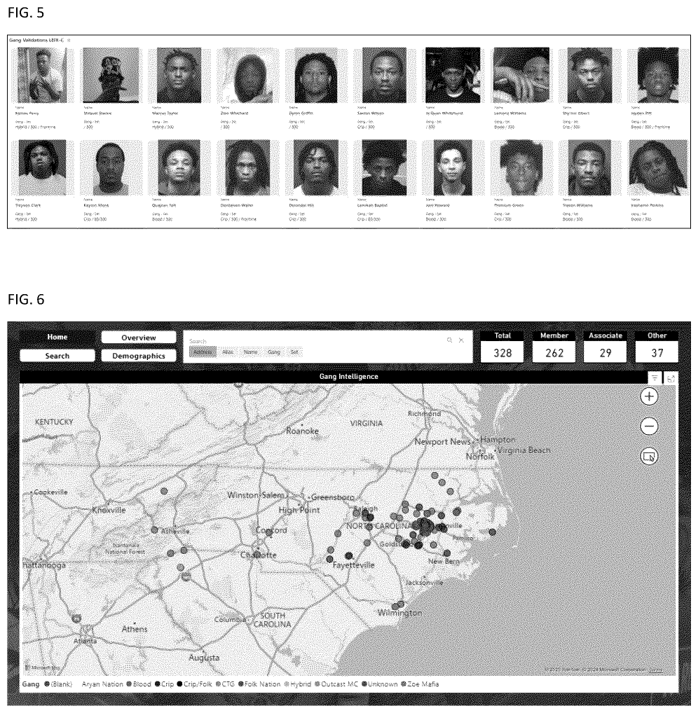

FIG. 5 is an embodiment of a gang validation dashboard.

FIG. 6 is an embodiment of a gang intelligence mapping interface.

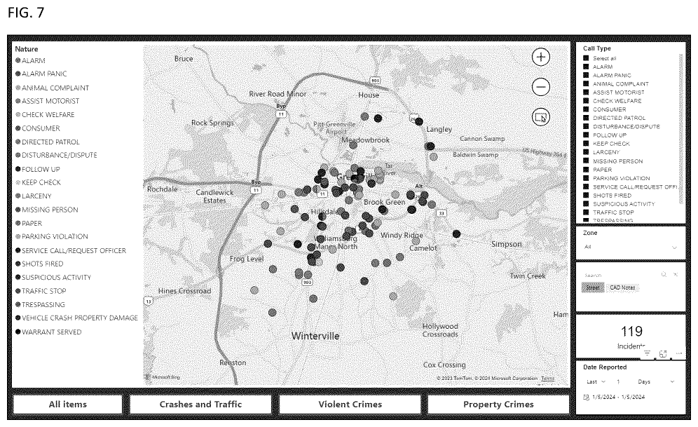

FIG. 7 is an embodiment of a calls for service and crime mapping interface.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A secure real-time online system for law enforcement to investigate time sensitive situations with information at different locations including digital and non-digital at the same time comprising:
a) a dashboard for accessing all information which allows a user to have interactions between multiple information sources via a navigation page;
b) an intelligence map that geocodes at least one of the locations of crimes, calls for law enforcement service, wanted subjects, and gang members on a map;
c) an identity investigation tool;
d) a secured host system which provides interactive connections to information; and
e) a user access system requiring a two-factor authentication.

2. The online system for law enforcement to investigate time sensitive situations according to claim 1 which further comprises at least one of an employee dashboard and a recruitment and retention dashboard, a wanted person dashboard, a library of law enforcement form, a display of calls for service and crimes on a map, and a gang validation map and a gang intelligence mapping interface.

3. The real-time online system according to claim 1 which further provides the ability to convert non-digital to digital.
